(19) United States
(12) Patent Application Publication
(10) Pub. No.: US 2008/0064006 A1
(43) Pub. Date: Mar. 13, 2008

(54) Ultrasonic Dental Tool

(75) Inventors: Christopher Quan, Houston, TX (US); Pejman Fani, San Diego, CA (US); Gregory Stein, Torrance, CA (US); Travis Pham, Los Angeles, CA (US); Brian Zargari, Los Angeles, CA (US)

Correspondence Address: DISCUS DENTAL IMPRESSIONS, INC., 8550 HIGUERA STREET, CULVER CITY, CA, 90232, US

(73) Assignee: DISCUS DENTAL, LLC, Culver City, CA (US)

(21) Appl. No.: 11/840,929

(22) Filed: Aug. 17, 2007

Related U.S. Application Data
(60) Provisional application No. 60/838,581, filed on Aug. 17, 2006.
(60) Provisional application No. 60/838,579, filed on Aug. 17, 2006.
(60) Provisional application No. 60/838,607, filed on Aug. 17, 2006.
(60) Provisional application No. 60/838,576, filed on Aug. 17, 2006.
(60) Provisional application No. 60/945,345, filed on Jun. 20, 2007.
(60) Provisional application No. 60/946,125, filed on Jun. 25, 2007.

(51) Int. Cl. A61C 1/07

(52) U.S. Cl. 433/119

(57) ABSTRACT

The present invention relates to ultrasonic dental tools having an integral sheath and at least one light source adapted to utilize the electromagnetic energy already available in the existing ultrasonic dental unit. The handpiece includes a substantially hollow housing having a primary power source that may include a coil. In one aspect, the ultrasonic dental insert includes a sheath. The sheath may be formed such that it may cover at least part of the handpiece housing. In general, the sheath may serve as a barrier such that it may reduce cross-contamination to and from the patient's mouth. During operation, the primary coil of the handpiece may be inductively coupled to an illumination energy coil such that the illumination energy coil may draw energy from the electromagnetic field of the primary coil to power at least one light emitting element.

### CROSS-REFERENCE TO RELATED APPLICATIONS

This application claims the benefit of U.S. provisional application Ser. Nos. 60/838,581, filed 17 Aug. 2006, entitled “ULTRASONIC DENTAL TOOL HAVING A LIGHT SOURCE”; 60/838,579, filed 17 Aug. 2006, entitled “ULTRASONIC DENTAL TOOL HAVING A LIGHT SOURCE”; 60/838,607, filed 17 Aug. 2006, entitled “ULTRASONIC DENTAL TOOL HAVING A LIGHT SOURCE”; 60/838,576, filed 17 Aug. 2006, entitled “ULTRASONIC DENTAL TOOL HAVING A LIGHT SOURCE”; 60/945,345, filed 20 Jun. 2007, entitled “ULTRASONIC DENTAL TOOL”; and 60/946,125, filed 25 Jun. 2007, entitled “ULTRASONIC DENTAL TOOL”, the contents of all of which are hereby incorporated by reference.

### FIELD OF THE INVENTION

The present invention is related to ultrasonic dental tools, and particularly to ultrasonic dental tools having at least one light source and/or a sheath.

### BACKGROUND OF THE INVENTION

Dental practitioners use ultrasonic dental tools (instruments) for dental treatments and procedures, such as scaling, periodontal treatments, root canal therapy, and the like. The ultrasonic dental tools typically include a handpiece coupled at one end (i.e., a proximal end) to an electrical energy and fluid source via a cable. The cable includes a hose to provide fluid (e.g., water) and conductors to provide electrical energy.

The other end (i.e., a distal end) of the handpiece has an opening intended to receive a replaceable insert with a transducer (e.g., magnetostrictive) integral to the insert. The transducer extends from a proximal end of the insert into a hollow interior of the handpiece. An ultrasonically vibrated tip extends from a distal end of the insert.

The ultrasonic dental insert and the handpiece are typically sterilized prior to use to prevent contamination and cross-contamination in the work environment. This results in multiple inserts and handpieces being needed to maintain steady work flow and sterilizations.

Since a mouth is a small space in which to work, it is often difficult to see well into all regions of the mouth under the best of conditions. When a dental practitioner cannot see clearly in the field of work, it is more likely that painful slips can occur. The often sharp implements, vibrating at ultrasonic frequencies, can do considerable harm to soft tissue (such as gum tissue) resulting in bleeding and pain.

The large and focused lamp that hangs over the field of work while the dental practitioner uses ultrasonic dental tools in the patient's mouth often becomes obscured when the dental practitioner leans closely toward the patient to work in confined spaces within the mouth. The suddenly darker field is more difficult in which to work accurately. Small slips and injuries can result.

Therefore, it is desirable to provide an ultrasonic dental tool that can bring light directly into the field of work (i.e., patient's mouth). If such light can be provided using a source of energy already available in existing ultrasonic dental units, circuit complexity and energy requirements can be reduced. It is also desirable to provide an ultrasonic dental tool that utilizes simplified sterilization procedures and enhances the maintenance of a clean work environment for patients.

### SUMMARY OF THE INVENTION

The present invention relates to ultrasonic dental tools having an integral sheath and at least one light source adapted to utilize the electromagnetic energy already available in the existing ultrasonic dental unit.

The ultrasonic dental tool generally includes a dental insert having a transducer for generating ultrasonic vibrations. The ultrasonic dental insert includes a housing and a connecting body having a proximal end and a distal end having a tip attached thereto or formed thereon. The proximal end is attached to the transducer so as to generate the ultrasonic vibrations therefrom and to transmit the ultrasonic vibrations toward the tip at the distal end.

The ultrasonic dental insert may be inserted into a handpiece for providing electromagnetic energy to the transducer to generate the ultrasonic vibrations. The handpiece includes a substantially hollow housing having a primary power source that may include a coil.

In one aspect, the ultrasonic dental insert includes a sheath. The sheath may be formed such that it may cover at least part of the handpiece housing. In general, the sheath may serve as a barrier such that it may reduce cross-contamination to and from the patient's mouth. The insert may, for example, be sterilized prior to use by methods such as autoclaving, alcohol sterilization, and/or any other appropriate method such that when the sheath covers the handpiece, it provides a sterile surface that may be inserted into the patient's mouth. The ultrasonic dental tool may then be used such that it is not necessary for the handpiece to be sterilized. The sheath may also help to prevent contaminants from one patient's mouth from being transferred to another patient or to the work area of the handpiece.

In an exemplary embodiment, the sheath is part of the insert and may be integrally formed onto the insert such that when the insert is inserted into the handpiece, the sheath may simultaneously cover at least a portion of the handpiece body. The sheath may be formed as part of a handgrip portion of the insert. The sheath may also be supported by other portions of the insert.

In some embodiments, the sheath may form a generally cylindrical cover over the handpiece body. The sheath may be of any desirable length and may cover only a portion of the handpiece body proximal to the insert tool tip. The sheath may also be of a length sufficient to cover substantially the entire length of the handpiece body.

During operation, the primary coil of the handpiece may be inductively coupled to an illumination energy coil such that the illumination energy coil may draw energy from the electromagnetic field of the primary coil to power at least one light emitting element. In one aspect, an ultrasonic dental tool includes at least one light source adapted to deliver light to the field of work. In an exemplary embodiment, a light source may be located proximal to the tip.

In an exemplary embodiment, the illumination energy coil may be located about the handpiece. The space within the handpiece for accommodating the magnetostrictive stack is often constrained. It may be desirable to locate the illumination energy coil outside the handpiece such that additional space accommodation within the handpiece may not be needed. This may also increase the compatibility of the illumination energy coil with various other handpieces.

In one embodiment, an ultrasonic insert may include at least one integral light source and an illumination energy coil. At least one conductor may be included to connect and carry electrical energy signals between the illumination energy coil and the light source (s). The illumination energy coil may then power the light source(s) by inductively coupling to the primary coil of the handpiece.

In one aspect, the illumination energy coil may be supported by a sheath integral to the ultrasonic dental insert. In one embodiment, the illumination energy coil may be contained within the sheath, which may position the coil for inductive coupling to the primary coil of the handpiece when the insert is inserted into the handpiece. In another embodiment, the coil may be disposed on the inner surface of the sheath. The sheath may, for example, be overmolded over the coil. The sheath may also be partially molded onto the insert and the coil may then be wound onto the partially molded sheath. The remainder of the sheath may then be overmolded over the coil such that it may be embedded in the material of the sheath.

In another aspect, an illumination energy coil may be disposed on the insert, for example, proximal to the connecting body, and generates a voltage signal in response to movement of a portion of the connecting body according to the ultrasonic vibrations. At least one light source, substantially proximate to the tip, may be connected to and receives the voltage signal from the illumination energy coil to generate light.

In some embodiments, an illumination energy coil may be present in the insert proximal to the connecting body. In other embodiments, an illumination energy coil may also be present in, supported by or disposed on the inner surface of a sheath integral to the insert. This illumination energy coil may be inductively coupled to the primary coil of the handpiece when the insert is inserted into the handpiece. The illumination energy coils may be joined electrically such that a light source may utilize the combined energy provided by the coils.

In one embodiment, the dental insert and/or handpiece may include a magnetic material or a magnetic source in close proximity for initiating, re-establishing, increasing and/or maintaining the brightness of the output light from the light source when in use.

In one aspect, at least one magnetic material may be in close proximity for increasing and/or maintaining the brightness of the output light from the light source when in use. In another aspect, a magnetic material or a magnetic source, for example, a magnet, may be used to initiate and/or re-establish proper magnetization of the metal connecting body for the purpose of allowing the connecting body to generate an electromagnetic field during operation of the insert.

In one embodiment, a magnetic material may be placed inside an appropriate holder and may be used to magnetize or re-magnetize an insert and tip to allow the connecting body to generate an electromagnetic field during operation of the insert and tip. In one aspect, the holder may be in the form of individual pockets disposed about the connecting body. In another aspect, the holder may be in the form of a ring with at least one pocket for holding at least one magnetic source. According to one embodiment, the magnetic source may be in the form of a rectangular block. The block may be thick or thin. According to another embodiment, the magnetic source may be of an arcuate form. The arcuate form may be in the shape of a horse shoe or a small arc.

In another embodiment, a magnetic material or magnetic source may be used to fashion at least a portion of the insert and/or the connecting body.

In a further embodiment, the magnetic material or source, such as a magnet, may be placed in the handgrip portion of the insert, to enable the connecting body, once magnetized, to retain its magnetic properties in an optimal manner even after exposure to heat or physical shock.

In yet another aspect, an ultrasonic dental tool includes at least one attachable light source. In one exemplary embodiment, an attachable light source may include at least one light emitting element, an illumination energy coil, an attachment means and a positioning member.

In one embodiment, an attachable light source may be mounted to the outside of the ultrasonic handpiece by sliding the structure of the illumination energy coil over the outside of the handpiece body.

In another embodiment, the attachable light source may include a positioning member that may connect the light emitting element(s) to the illumination energy coil and place the light emitting element(s) in position to light the field of work.

In some embodiments, the positioning member may be a flexible arm that may allow easy manipulation, orientation and positioning of the light emitting element(s).

In other embodiments, the positioning member may be a rigid arm that may substantially fix the position and orientation of the light emitting element(s).

In further embodiments, the positioning member may be an adjustable arm that may provide a broad range of positions and/or orientations for the light emitting element (s). The positioning member may also substantially retain any position and/or orientation of the light emitting element(s) between adjustments.

In another aspect, an ultrasonic dental tool includes at least one attachable light source and may deliver light to the field of work. An attachable light source may include at least one light emitting element, an illumination energy coil and an attachment means.

In an exemplary embodiment, the attachable light source may include at least one light emitting element disposed in close proximity to the illumination energy coil and/or the attachment means. The attachable light source may also include a light guide or light pipe that may carry light from the light emitting element(s) to the field of work.

In still another aspect, an ultrasonic dental tool includes at least one attachable light source and may deliver light to the field of work. An attachable light source may include at least one light emitting element, an illumination energy coil, an attachment means and a positioning member.

In an exemplary embodiment, an attachable light source may include an internal illumination energy coil and may be mounted to the outside of the ultrasonic handpiece. The attachable light source may be mounted such that the axis of illumination energy coil and the primary coil of the handpiece are parallel. The illumination energy coil may also be held in close proximity to the handpiece such that it may be inductively coupled to the primary coil.

In another exemplary embodiment, the illumination energy coil may include a core element that may be used to enhance or tune the output of the illumination energy coil. The core element may be composed of any material conducive to enhancing the magnetic field of the illumination energy coil. Examples may include any magnetic materials, such as, for example, iron, steel, ferrite, various transition metals, alloys, combinations and/or other appropriate materials that may serve to concentrate the magnetic field of the illumination energy coil.

The core element may be any shape or form that may aid in the enhancement and/or tuning of the illumination energy coil. Examples may include straight cylinders, “E” cores, “I” cores, double “E” cores, pot cores, toroidal cores and/or any other appropriate shapes or forms.

In some embodiments, the core element may include an adjustment means that may allow the core to be moved with respect to the illumination energy coil. This may allow the illumination energy coil to be tuned, which may allow the output of the coil to be modulated.

In an alternative embodiment, the attachable light source may include multiple illumination energy coils that may be disposed in a parallel physical orientation about the handpiece such that each coil may access a different region of magnetic flux from the primary coil. The illumination energy coils may also be connected electrically in a manner to sum either the current or the voltage generated.

In yet another aspect, a light source may be integrally included in an ultrasonic dental scaling insert. The insert may include at least one integrated light source and an illumination energy coil that may be mounted such that it may be inductively coupled to the primary coil of an ultrasonic handpiece.

In an exemplary embodiment, an ultrasonic insert may include at least one integral light source, a mounting arm and an illumination energy coil. The mounting arm may connect the illumination energy coil to the insert body and may carry electrical signals between the illumination energy coil and the light source (s). The mounting arm may also substantially fix the position of the illumination energy coil such that it may slide over the outside of the handpiece when the insert is inserted into the body of the handpiece. The illumination energy coil may then power the light source(s) by inductively coupling to the primary coil of the handpiece.

In some embodiments, the illumination energy coil may be disposed in and/or supported by a sheath. The sheath may be positioned over the handpiece to inductively couple the illumination energy coil to the primary coil of the handpiece to provide power to the at least one light source.

In some aspects, the illumination energy coil may include a form of rectification circuitry that may improve utilization of the alternating current of the voltage signal. A form of rectification circuitry may include half-wave rectifiers and full-wave rectifiers.

In some aspects, an output smoothing circuit may also be included in the circuitry of the illumination energy coil and light source that may effectively reduce the variation in voltage over the time of use and may thus increase the lifespan of the light source as well as reduce any variations in the amount of light delivered to the field of work. An output smoothing circuit may include a Zener diode, a reservoir capacitor, a capacitor-input filter and/or any other appropriate circuit element(s) that may effectively reduce variations in the voltage over time at the light source.

In a further aspect, the ultrasonic dental tool may include monitoring systems for tool usage and condition. The dental tool may include, for example, usage time monitoring circuitry, wear usage circuitry, electromagnetic monitoring circuitry and/or any other appropriate monitoring systems.

In an exemplary embodiment, the ultrasonic dental tool may include a time monitoring circuit. The time monitoring circuit may record the usage time of an ultrasonic dental insert.

In a further exemplary embodiment, a control mechanism may be provided to inhibit the use of an insert on a patient after it has reached the predetermined maximum usage time. One aspect of the control mechanism is that the inhibition occurs during the attachment process of the insert to the handpiece.

In yet another exemplary embodiment, a control mechanism may be provided to inhibit the use of an insert when the insert does not have an identification marker that is recognized by the unit and/or handpiece. One aspect of the control mechanism is that the inhibition occurs during the attachment process of the insert to the handpiece. In one embodiment, the control mechanism inhibits the operation of the unit. In another embodiment, the control mechanism inhibits the operation of the handpiece.

The light source may be proximate or distal to the tip. If the light source is distal to the tip, then a light guide or light pipe may be included for transmitting light towards the tip.

The present invention together with the above and other advantages may best be understood from the following detailed description of the embodiments of the invention illustrated in the drawings.

### BRIEF DESCRIPTION OF THE FIGURES

FIG. 1 illustrates an embodiment of an ultrasonic dental insert and a partial see-through of an ultrasonic dental handpiece;

FIG. 2 illustrates an embodiment of an ultrasonic dental insert with an integral sheath;

FIG. 2a shows a partial see-through perspective view of the insert of FIG. 2;

FIGS. 2b and 2c illustrate embodiments of inserts with different length integral sheaths;

FIG. 3 shows a partial see-through perspective view of an insert with an illumination energy coil and a light source;

FIGS. 3a and 3b show partial see-through perspective views of inserts with light sources and light transports;

FIGS. 4 and 4a illustrate inserting an insert with an integral sheath into a handpiece;

FIG. 5 illustrates an embodiment of an insert with an illumination energy coil outside the insert housing and a light source;

FIG. 5a illustrates the insert of FIG. 5 inserted into a handpiece;

FIG. 5b shows a partial see-through perspective view of an insert with an integral sheath, illumination energy coil and a light source inserted into a handpiece;

FIGS. 6-6c show light emitting circuitry of attachable or integrated light sources featuring half and full wave rectification means in exemplary embodiments of the invention;

FIGS. 7-7b show light emitting circuitry of attachable or integrated light sources featuring voltage smoothing means in exemplary embodiments of the invention;

FIG. 8 shows a perspective view of an ultrasonic dental tool including an ultrasonic handpiece, scaling insert and attached light source;

FIG. 8a is an exploded perspective view of the ultrasonic dental tool of FIG. 8;

FIG. 9 shows a perspective view of an attachable light source with a flexible arm in an embodiment of the invention;

FIG. 9a shows a perspective view of an attachable light source with a rigid arm in an alternative embodiment of the invention;

FIG. 9b shows a perspective view of an attachable light source with an adjustable arm in another embodiment of the invention;

FIG. 10 shows a perspective view of an attachable light source in an embodiment of the invention;

FIG. 10a shows the attachable light source of FIG. 10 with an attached light guide;

FIG. 11 shows a perspective view of an attachable light source in an embodiment of the invention;

FIG. 11a shows a perspective view of an ultrasonic dental tool with an ultrasonic handpiece, scaling insert and the attachable light source of FIG. 4;

FIG. 11b is an exploded perspective view of the ultrasonic dental tool of FIG. 11a;

FIG. 11c shows a perspective view of an illumination energy coil in an embodiment of the invention;

FIG. 11d shows a partial cross-sectional view of an attachable light source with an adjusting means in another embodiment of the invention;

FIG. 12 shows a perspective view of an ultrasonic dental tool with an ultrasonic handpiece and a scaling insert with an integrated light source and illumination energy coil in an embodiment of the invention;

FIG. 12a shows an exploded perspective view of the ultrasonic dental tool of FIG. 12;

FIGS. 12b and 12c show perspective views of an ultrasonic dental tool with an ultrasonic handpiece and a scaling insert with an integrated light source and attachable illumination energy coil in an embodiment of the invention.

### DETAILED DESCRIPTION OF THE INVENTION

The detailed description set forth below is intended as a description of the presently exemplified device provided in accordance with aspects of the present invention and is not intended to represent the only forms in which the present invention may be practiced or utilized. It is to be understood, however, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the exemplified methods, devices and materials are now described.

The present invention relates to ultrasonic dental tools having an integral sheath and at least one light source adapted to utilize the electromagnetic energy already available in the existing ultrasonic dental unit.

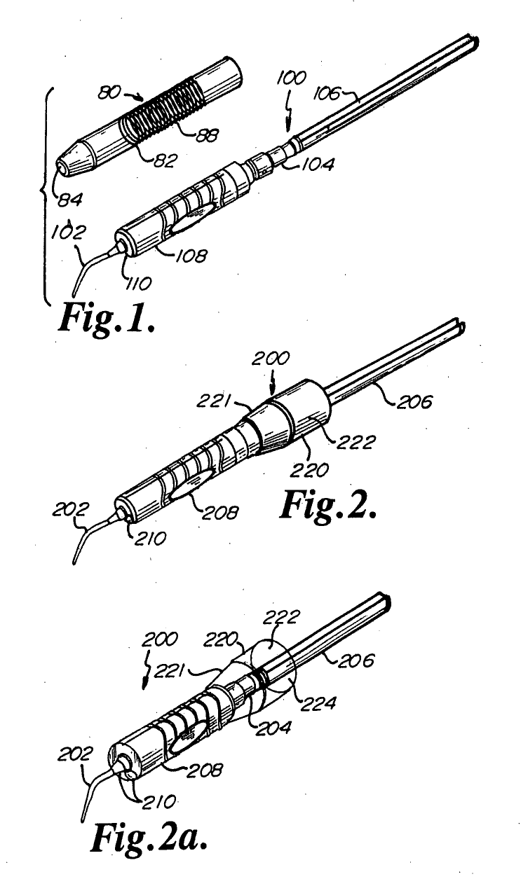

An ultrasonic dental tool generally includes a dental insert having a transducer for generating ultrasonic vibrations. FIG. 1 illustrates an ultrasonic dental insert 100 which includes a housing 108 and a connecting body 104 having a proximal end and a distal end having a tip 102 attached thereto or formed thereon. The proximal end of the connecting body 104 is attached to a transducer 106 so as to generate the ultrasonic vibrations therefrom and to transmit the ultrasonic vibrations toward the tip 102 attached to the distal end. The insert 100 may also include a light source 110.

The ultrasonic dental insert 100 may be inserted into an aperture 84 of a handpiece 80 (not shown to scale) for providing electromagnetic energy to the transducer 106 to generate the ultrasonic vibrations. The handpiece 80 includes a substantially hollow housing 82 having a primary power source that may include a primary coil 88, which may be disposed inside the hollow housing 82 (as shown in partial transparent view).

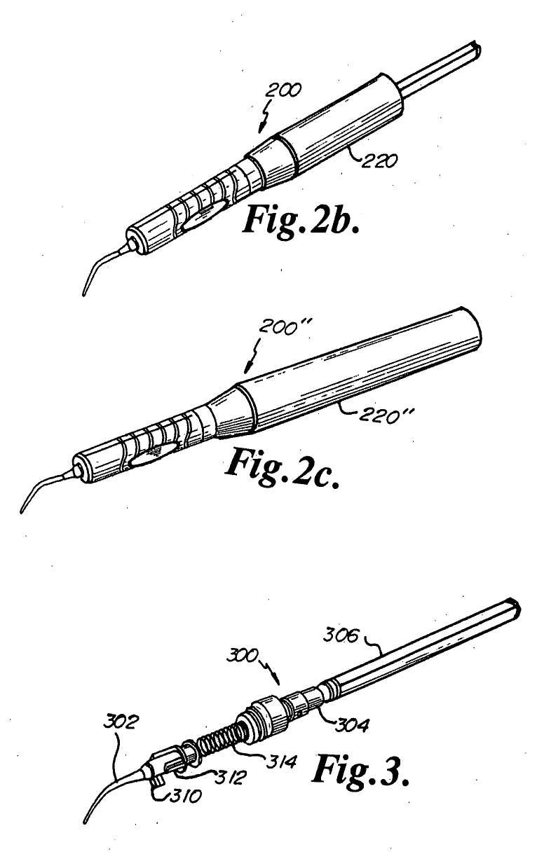

In one aspect, an ultrasonic dental insert includes a sheath 220. FIG. 2 illustrates an embodiment of an insert 200 that includes a sheath 220. The sheath 220 may be formed such that it may cover at least part of a handpiece housing 82 when inserted into a handpiece 80. In general, the sheath 220 may serve as a barrier such that it may reduce cross-contamination to and from the patient's mouth. The insert 200 may, for example, be sterilized prior to use by methods such as autoclaving, alcohol sterilization, and/or any other appropriate method such that when the sheath covers the handpiece 80, it may provide a sterile surface that may be inserted into the patient's mouth, as noted before. The ultrasonic dental tool may then be used without sterilizing of the handpiece 80. The sheath 220 may also help to prevent contaminants from one patient's mouth from being transferred to another patient or to the work area by the handpiece.

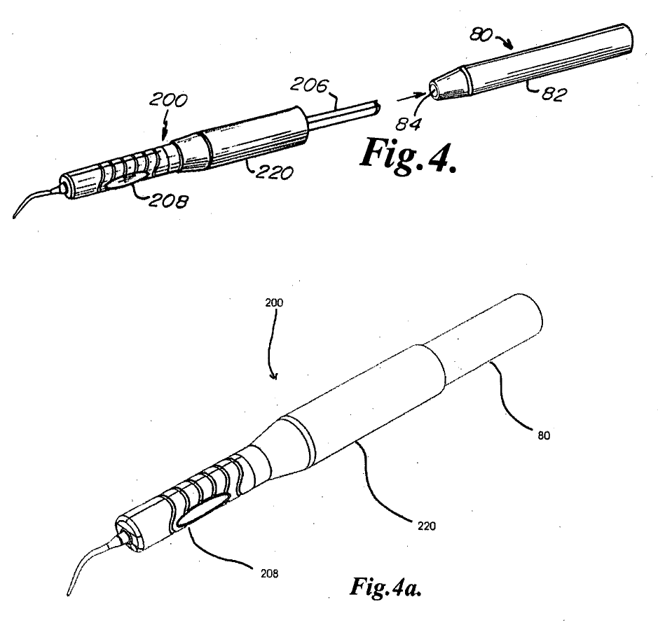

In an exemplary embodiment, as illustrated in FIGS. 4 and 4a, the sheath 220 may be integrally formed onto the insert 200 about the transducer 206 such that when the insert 200 is inserted into the handpiece 80, the sheath 220 may simultaneously cover at least a portion of the handpiece housing 82 while the transducer 206 is inserted into aperture 84 the handpiece 80. The sheath 220 may be formed as part of a handgrip portion of the insert housing 208. The sheath 220 may also be supported by other portions of the insert 200.

In some embodiments, the sheath 220 may have a generally cylindrical section 222 with a hollow interior 224 which may fit over the handpiece housing 82. The sheath 220 may generally include an expansion section 221 which may span the size difference between the insert housing 208 and the section 222 which may be larger than the handpiece housing 82. The sheath 220 may be of any desirable length and may cover only a portion of the proximal end of the handpiece housing 82, as shown in FIGS. 2, 2a and 2b. The sheath 220 may also be of a length sufficient to cover substantially the entire length of the handpiece housing 82, as shown in FIG. 2c.

The sheath 220 may generally be constructed of any appropriate material. In some embodiments, the material of the sheath 220 may be the same as the insert housing 208. In other embodiments, it may be a different material. In general, it may be desirable for the sheath 220 to have sufficient rigidity such that it may consistently fit over a handpiece 80 and may not collapse between uses. The sheath 220 may also generally be constructed to withstand multiple sterilization procedures, such as by autoclave. Examples of appropriate materials may include, but are not limited to, for example, a polymer that may be molded or cast. Suitable polymers include polyethylene, polypropylene, polybutylene, polystyrene, polyester, acrylic polymers, polyvinylchloride, polyamide, or polyetherimide like ULTEM®; a polymeric alloy such as Xenoy® resin, which is a composite of polycarbonate and polybutyleneterephthalate or Lexan® plastic, which is a copolymer of polycarbonate and isophthalate terephthalate resorcinol resin (all available from GE Plastics), polycarbonate, acetal, polyetheretherketone (PEEK), liquid crystal polymers, such as an aromatic polyester or an aromatic polyester amide containing, as a constituent, at least one compound selected from the group consisting of an aromatic hydroxycarboxylic acid (such as hydroxybenzoate (rigid monomer), hydroxynaphthoate (flexible monomer), an aromatic hydroxyamine and an aromatic diamine, (exemplified in U.S. Pat. Nos. 6,242,063, 6,274,242, 6,643,552 and 6,797,198, the contents of which are incorporated herein by reference), polyesterimide anhydrides with terminal anhydride group or lateral anhydrides (exemplified in U.S. Pat. No. 6,730,377, the content of which is incorporated herein by reference) or combinations thereof.

In some embodiments, the sheath 220 may include multiple materials. The sheath 220 may, for example, include support members which may enhance and/or maintain its form and/or rigidity.

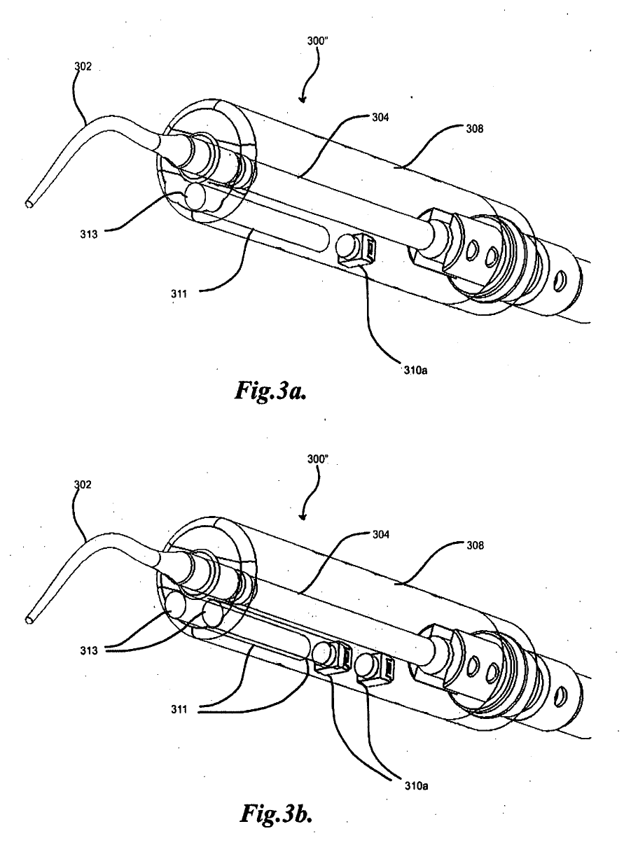

In another aspect, as illustrated in FIG. 3, an illumination energy coil 314 may be disposed on an insert 300′, for example, proximal to the connecting body 304, and generates a voltage signal in response to movement of a portion of the connecting body 304 according to the ultrasonic vibrations. At least one light source 310, substantially proximate to the tip 302, may be connected to and receives the voltage signal from the illumination energy coil 314 to generate light.

In another embodiment, as shown in FIG. 3a, an insert 300″ may include a light source 310a, which may be disposed distal to the tip 302, and a light transport 311, such as a light guide or light pipe exit point may be used. The light transport 311 may in general carry light from the light source 310a to a light exit 313 which may be disposed such that light may be directed to the field of work. The light source 310a and the light transport 311 may in general be enclosed by the hand grip 308.

In other embodiments, a plurality of light ports 313, with their respective light sources 310a and light transports 311, as shown in FIG. 3b, may be integrated with the insert 300″. The plurality of light sources 310a can also have one light port 310″. In still other embodiments, the light transports 311 may not be integrated with the insert 300″, but may instead be non-integrally attached to the insert 300″ and/or the hand grip 308, or only one light transport 311 is integrated with the insert 300″ and additional ones are not.

The light transports 311, as shown in FIGS. 3a and 3b, such as the light exit ends of fiber optic bundles, may be individual elements running from the light source 310a to the light exits 313 or they may form part of illumination energy coil 314 (not shown), the hand grip 308 or the connecting body 304.

In some embodiments, the dental insert 300′ and/or handpiece 80 may include a magnetic material or a magnetic source in close proximity for initiating, re-establishing, increasing and/or maintaining the brightness of the output light from the light source 310 when in use.

In one aspect, at least one magnetic material may be in close proximity to the insert 300′ for increasing and/or maintaining the brightness of the output light from the light source when in use. In another aspect, a magnetic material or a magnetic source, for example, a magnet, may be used to initiate and/or re-establish proper magnetization of the metal connecting body 304 for the purpose of allowing the connecting body 304 to generate an electromagnetic field during operation of the insert 300′. An example is shown in FIG. 3.

In one embodiment, a magnetic material 312 may be placed inside the insert housing 308 to magnetize or re-magnetize connecting body 304 to allow the connecting body 304 to generate an electromagnetic field during operation of the insert 300′ and tip 302. In one aspect, the magnetic material 312 may be present in a holder, which may be in the form of individual pockets disposed about the connecting body 304. In another aspect, the holder may be in the form of a ring with at least one pocket for holding at least one magnetic material 312. According to one embodiment, the magnetic material 312 may be in the form of a rectangular block. The block may be thick or thin. According to another embodiment, the magnetic material 312 may be of an arcuate form. The arcuate form may be in the shape of a horse shoe or a small arc.

In another embodiment, a magnetic material 312 may be used to fashion at least a portion of the insert 300′ and/or the connecting body 304.

In a further embodiment, the magnetic material 312, such as a magnet, may be placed in the handgrip portion of the insert housing 308, as exemplified in FIG. 3, to enable the connecting body 304, once magnetized, to retain its magnetic properties in an optimal manner even after exposure to heat or physical shock.

During operation, the primary coil 88 of the handpiece 80 may be inductively coupled to an illumination energy coil such that the illumination energy coil may draw energy from the electromagnetic field of the primary coil 88 to power at least one light emitting element, as shown in FIG. 1. In one aspect, an ultrasonic dental tool includes at least one light source and may be located to deliver light to the field of work. In an exemplary embodiment, a light source may be located proximal to the tip.

In some embodiments, an illumination energy coil 314 may be present in the insert housing 308 proximal to the connecting body 304, as shown in FIG. 3. In other embodiments, an illumination energy coil 314 may be external to the insert housing 308, examples of which are described below.

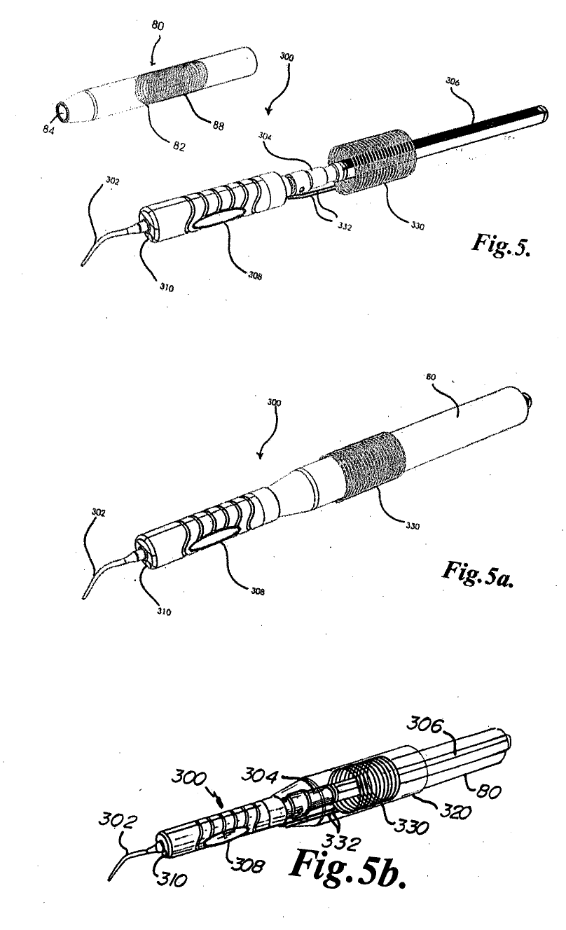

FIG. 5 illustrates an embodiment of an insert 300 which includes an illumination energy coil 330 which is disposed about the transducer 306. The illumination energy coil 330 connects to the insert housing 308 and may supply electrical energy via electrical conductors 332 to the light source 310. This illumination energy coil 330 may be inductively coupled to the primary coil 88 of the handpiece 80 when the insert 300 is inserted into the handpiece 80.

In an exemplary embodiment, the illumination energy coil 330 may be located about the handpiece housing 82, as shown in FIG. 5a. The space within the handpiece 80 that may accommodate the transducer 306 is often constrained. It may be desirable to locate the illumination energy coil 330 outside the handpiece 80 such that additional space accommodation within the handpiece 80 may not be needed. This may also increase the compatibility of the illumination energy coil 330 with various handpieces.

In one aspect, the illumination energy coil 330 may be supported by a sheath 320 integral to the ultrasonic dental insert 300, as shown in FIG. 5b. In one embodiment, the illumination energy coil 330 may be contained within the sheath 320, which may position the coil 330 for inductive coupling to the primary coil 88 of the handpiece 80 when the insert 300 is inserted into the handpiece 80. In another embodiment, the coil 330 may be disposed on the inner surface of the sheath 320. The sheath 320 may, for example, be overmolded over the coil 330. The sheath 320 may also be partially molded onto the insert 300 and the coil 330 may then be wound onto the partially molded sheath 320. The remainder of the sheath 320 may then be overmolded over the coil 330 such that it may be embedded in the material of the sheath 320. In general, the coil 330 may be disposed between the handpiece 80 and at least a portion of the sheath 320 and/or otherwise supported by the sheath 320.

In some embodiments, the illumination energy coils 314, 330 may be joined electrically such that a light source 310 may utilize the combined energy provided by the coils 314, 330.

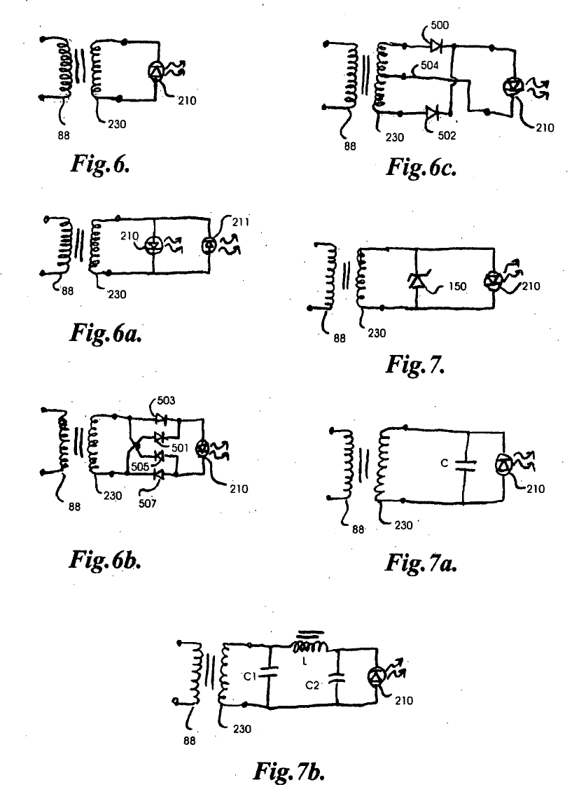

In the light emitting circuitry of FIG. 6, the light source may be an LED 210 connected in series with the illumination energy coil 230. Since the LED 210 emits light in response only to a voltage having single polarity, it emits light only half the time since the illumination energy coil 230 generates an AC voltage signal. However, since the LED 210 switches off and on at ultrasonic frequency (e.g., 25 kHz), such rapid switching of the LED is generally imperceptible to human eyes, and the LED 210 would appear to be continuously on. In other embodiments, the light source 210 may be any other suitable light emitting device such as an incandescent lamp (e.g., halogen light bulb).

In FIG. 6a, an LED 211 is connected in an anti-parallel relationship with the LED 210, such that they are connected in parallel but in opposite directions. This way, the LEDs 210 and 211 are alternately turned on in response to the ac voltage generated by the illumination energy coil 230. Since the ac voltage has an ultrasonic frequency (e.g., 25 kHz), the switching on and off of the LEDs 210 and 211 is imperceptible to human eyes, and therefore, both the LEDs 210 and 211 would appear to be on continuously.

In some embodiments, full-wave rectification circuitry may be employed such that the light source may utilize both the positive and negative phases of the ac current voltage signal. A full-wave rectification circuit may include, for example, a full bridge rectifier. A full bridge rectifier, may include 4 diodes 501, 503, 505, 507 that may be connected in such a way as to produce a full-wave rectified direct current voltage signal at the light source 210 from the ac current voltage signal generated by the illumination energy coil 230, as illustrated in FIG. 6b. The various circuit connections and one possible polarity arrangement of the diodes 501, 503, 505, 507 the illumination energy coil 230 and the light source 210. It is also conceived that an opposite polarity arrangement may also be utilized while producing identical physical arrangement and performance.

The center-tapped configuration discussed above may generate a full-wave rectified direct current voltage signal at the light source 210 from the ac current voltage signal generated by the illumination energy coil 230. The circuit diagram shown in FIG. 6c illustrates the various circuit connections and one possible polarity arrangement of the diodes 500, 502, the illumination energy coil 230 and the light source 210. It is also conceived that an opposite polarity arrangement may also be utilized while producing identical physical arrangement and performance.

In further embodiments, the light emitting circuitry may include voltage smoothing means. Voltage smoothing means may, for example, include a reservoir capacitor, a capacitor-input filter and/or any other circuit elements that may substantially smooth or lessen the variance in output voltage signal generated by the illumination energy coil. Such voltage smoothing means may operate in general by utilizing variations in the potential of an input voltage signal and may storing energy during from at least a part of the voltage signal while releasing stored energy during at least another part of the voltage signal. Voltage smoothing circuitry may include capacitors, inductors and/or any other appropriate circuit elements that may aid in responding to varying electrical potentials and/or storing electrical energy.

In the light emitting circuitry of FIG. 7, a Zener diode 150 is connected in parallel to the LED 210. The Zener diode 150 clamps the voltage such that the voltage differential seen by the LED 210 does not rise over a certain predetermined voltage. This way, the brightness of the LED 210 may be kept substantially uniform even if the energy illumination coil 230 begins to generate higher voltage due to any fluctuation of the energy source or other environmental conditions. By way of example, the Zener diode 150 may clamp the voltage at 5 volts (V), such that the voltage seen by the LED 210 is no greater than 5V.

FIGS. 7a and 7b show circuit diagrams of light emitting circuitry featuring examples of voltage smoothing means between illumination energy coil 230 and light source 210. FIG. 7a illustrates the use of a reservoir capacitor C, which may substantially lessen the variation of the voltage signal observed at the light source 210. FIG. 7b illustrates the use of a capacitor-input filter, which may include a reservoir capacitor C1 as well as a filter capacitor C2 and an inductor choke L. The embodiments illustrated may also feature other circuitry, such as rectification means and may continue to function with voltage smoothing by preserving the proper electrical interactions between the components of the circuit.

Reductions in voltage variance at the light source may, for example, aid in increasing the effective lifespan of the light source by minimizing electrical stress due to input variance or “on/off” stress. Reducing voltage variance may also generate a more steady light output and may increase the overall light output over time.

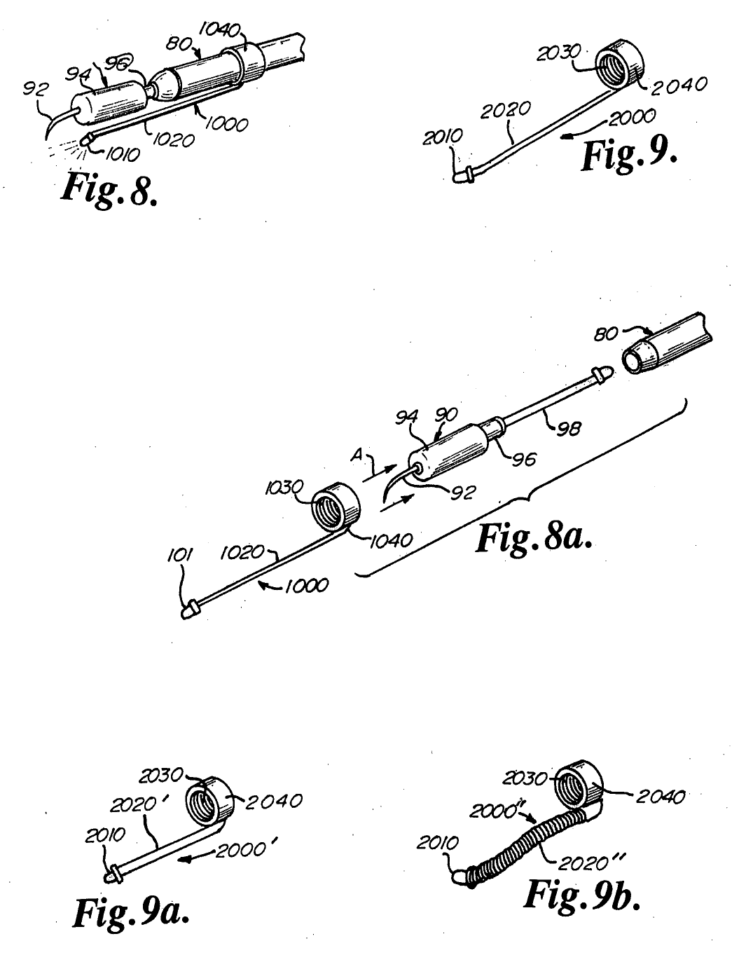

FIG. 8 illustrates an ultrasonic dental tool including an ultrasonic handpiece 80, an insert 90 and an attachable light source 1000. The handpiece 80 may include a primary coil that may produce a magnetic field from electrical current supplied from a cable (not shown). The insert 90 may include a scaling tip 92, a handgrip portion 94, a connecting body 96 and a magnetostrictive stack 98, as shown in more detail in FIG. 8a.

The attachable light source 1000 may include at least one light emitting element 1010, a positioning member 1020, an illumination energy coil 1030 and a body 1040. The illumination energy coil 1030 may be mounted about the body of the handpiece 80 by slipping on the body 1040 of the light source 1000. The light emitting element 1010 may be positioned and oriented toward the field of work by means of the positioning member 1020 which may extend from the body 1040 toward the tip 92 of the insert 90.

In one aspect, the illumination energy coil 1030 may be inductively coupled to the primary coil of the handpiece 80, which may then induce an AC current within the illumination energy coil 1030. The current may then power the light emitting element 1010 by way of electrical conductors within the positioning member 1020.

FIG. 9 illustrates an attachable light source 2000 in one aspect of the present invention. The attachable light source 2000 may include at least one light emitting element 2010, a positioning member 2020, an illumination energy coil 2030 and a body 2040.

In some embodiments, the positioning member 2000 may be constructed to be substantially flexible and/or non-rigid such that it may allow a large freedom of positioning and/or orientation for the light emitting element 2010. The positioning member 2000 may be constructed from any material and/or combination of materials that may be substantially flexible, such as, for example, natural rubber, synthetic rubber, silicone and/or any other appropriate material or combination. The material may also have elastic properties such that any deformation may be substantially reversible.

In other embodiments, the positioning member may be constructed to be substantially rigid, such as seen in FIG. 9a. The attachable light source 2000′, which may be substantially identical to the attachable light source 2000, may include a rigid positioning member 2020′ in place of a flexible member 2020. The rigid positioning member 2020′ may substantially fix the position and orientation of the light emitting element 2010 in relation to the body 2040 of the light source 2000′. The rigid positioning member 2020′ may be constructed from any material and/or combination of materials that may provide the required rigidity of the member, such as, for example, polymers including polyesters, metals and/or any other appropriate material or combination.

In still other embodiments, the positioning member may be constructed to be adjustable such that it may be deformed to position/orient the light emitting element and hold the adjustment until another adjustment is made, such as seen in FIG. 9b. The attachable light source 2000″ may be substantially identical to the embodiments shown in FIGS. 9 and 9a, but may include an adjustable positioning member 2020″ in place of the aforementioned positioning members. The adjustable positioning member 2020″ may be constructed in a manner such that it incorporates the proper deformation properties that may allow it to adjust and hold the position/orientation of the light emitting element 2010. The adjustable positioning member 2020″ may be constructed of a variety of materials and/or combinations of materials or it may be constructed with multiple components. The adjustable positioning member 2020″ may in general include a structural member that may incorporate substantial ductility into its design, such that it may impart significant ability to undergo plastic deformations without fracture and/or elastic recoil. Highly ductile materials, such as, for example, copper, aluminum, steel and/or any other suitable material may be included in the structure of the adjustable positioning member 2020″.

In another aspect, an attachable light source may include an illumination energy coil, a body and at least one light emitting element that may be disposed in close proximity to the body. FIG. 10 illustrates an embodiment of an attachable light source 3000 that includes a light emitting element 3010 mounted within a light module 3020 that may be disposed or formed on the body 3040.

FIG. 10a illustrates an exemplary embodiment, wherein the attachable light source 3000 may be adapted to produce light in close proximity to the body 3040 and deliver said light to the field of work through a light guide or light pipe 3050. A light guide or light pipe 3050 may be mounted onto the light module 3020 such that it may transmit light emitted from light emitting element 3010 to the field of work.

The light guide or light pipe 3050 may be constructed from any appropriate material that may substantially transmit light. The light guide or light pipe 3050 may be, for example, a fiber optic member that may be a single fiber or a bundle of fibers, a solid light guide such as glass or any suitable transparent/translucent polymer, and/or any other solid light transmitting material. In other embodiments, light guide or light pipe 3050 may be a hollow gas-filled, fluid-filled or vacuum space.

In some embodiments, the light guide or light pipe 3050 may be internally reflective such as to allow light emission from only the tip. In other embodiments, the light guide or light pipe 3050 may allow light emission from its walls.

In another embodiment, the light guide or light pipe 3050 may be constructed from an elastic and/or flexible light transmitting material such that it may be deformed to adjust the direction of the output light.

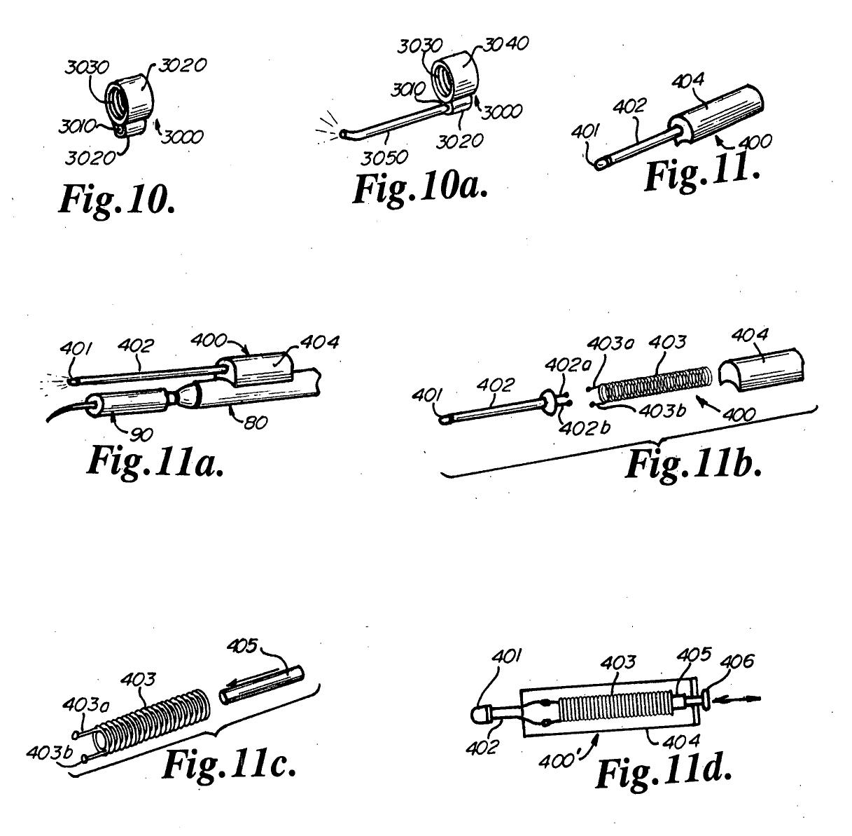

In still another aspect, an attachable light source may be adapted to attach to an ultrasonic handpiece in a non-surrounding manner. FIG. 11 illustrates an embodiment of an attachable light source 400 that may be attached to substantially only one portion of the body of an ultrasonic handpiece 80, as illustrated in FIG. 11a. The attachable light source 400 may include at least one light emitting element 401, a positioning member 402, an illumination energy coil 403 and a housing 404, as shown in FIG. 11b.

In an exemplary embodiment, the illumination energy coil 403 may be disposed within the housing 404, as shown in FIG. 11b such that its axis lies parallel to the axis of the primary coil of the handpiece 80. The illumination energy coil 403 may then be inductively coupled to the primary coil of the handpiece 80 and as such may provide power to the light emitting element 401 by coupling coil ends 403a, 403b to electrodes 402a, 402b.

In another exemplary embodiment, the illumination energy coil 403 may include a core element 405, as shown in FIG. 11c. The core element 405 may aid in concentrating and/or enhancing the magnetic field properties of the illumination energy coil 403 and may lie partially or substantially within the hollow space of the illumination energy coil 403. The core element 405 may be constructed of any material that may aid in concentrating a magnetic field, such as, for example, ferromagnetic materials including iron, steel, cobalt, nickel, magnetic alloys, magnetic ceramics including ferrite, and/or any other appropriate material capable of concentrating a magnetic field. The core element 405 may also take any form or shape that may be conducive to concentrating and/or enhancing the magnetic properties of the illumination energy coil 403. Such shapes and/or forms may include, but are not limited to, straight cylinders, straight bars, “E” cores, “I” cores, double “E” cores, pot cores, toroidal cores and/or any other appropriate shapes or forms.

In some embodiments, the core element 405 may be adapted to effectively tune and/or alter the electromagnetic properties of the illumination energy coil 403. This may be accomplished by moving the core element 405 in relation to the illumination energy coil 403, such as shown in FIG. 11d. A tuning knob or screw 406 may be included in the housing of the attachable light source 400′ to allow manual manipulation of the position of the core element 405 with relation to the illumination energy coil 403.

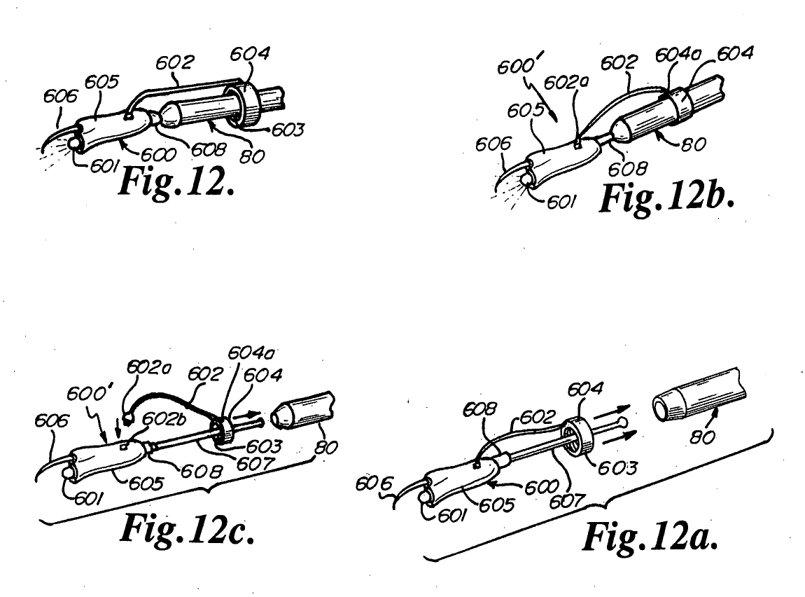

In yet another aspect, an ultrasonic dental tool may include an ultrasonic insert that may include an integral light source and an illumination energy coil. FIG. 12 and FIG. 12a illustrates an exemplary embodiment of an ultrasonic insert 600 that may include at least one integral light source 601, a scaling tip 606, a body portion 605, a connecting body 608, a magnetostrictive stack 607, a mounting arm 605 and an illumination energy coil 603 that may be mounted within a sheath 604. The insert 600 may be inserted into an ultrasonic handpiece 80 such that the illumination energy coil 603 may be disposed about the body of the handpiece so it may be inductively coupled to the primary coil therein. The illumination energy coil 603 may then power the light source 601 through electrical connections within the insert body 605 and the mounting arm 602.

The ultrasonic insert 600 may include a tip 606 at its distal end and a magnetostrictive stack 607 at its proximal end. The tip 606 is coupled to the stack 607 via a connecting body 608, which may take the form of, for example, a shaft. The tip 606 may be permanently or removably attached to the connecting body 608. When removably attached, the tips 606 may be interchanged depending on the desired application. Further, the tip 606 may be disposed of or steam autoclaved, or otherwise sterilized, after detaching it from the rest of the ultrasonic insert 600. For example, the tip 606 may be made using high temperature plastic such as a polyetherimide like ULTEM®, which is an amorphous thermoplastic polyetherimide; a polymeric alloy such as Xenoy® resin, which is a composite of polycarbonate and polybutyleneterephthalate or Lexan® plastic, which is a copolymer of polycarbonate and isophthalate terephthalate resorcinol resin, all available from GE Plastics; a liquid crystal polymer; or any other suitable resin plastic or composite. The term “plastic” is used herein to generally designate synthetic polymeric material, such as resin. The tip 606 may also be made of metal or metallic alloys such as stainless steel, which is particularly suitable when the tip is permanently attached to the insert 600. The attachment method may include any non-removable attachment such as soldering, welding, brazing, or the tip 606 may also be integrally formed as part of the connecting body 608.

The connecting body 608 may be made of any material that is suitable for transmitting ultrasonic vibrations, such as stainless steel or other metals. The connecting body 608 is used to deliver ultrasonic vibrations generated by the stack 607 to the tip 606. The stack 607, for example, may be attached to the connecting body 608 by soldering, welding, laser welding and/or any other suitable method. For example, the joint between the connecting body 608 and the stack 607 may be a brazed joint formed using a brazing compound, which includes cadmium free silver solder and high temperature brazing flux.

The stack 607, may, for example, include a stack of thin nickel plates arranged in parallel with respect to one another. Since the stack 607 generates ultrasonic vibrations in the dental tool, the stack 607 may also be referred to as a motor. In one embodiment the thin nickel plates may include 16 laminated nickel alloy strips, which are 90% nickel manganese (NiMn). The nickel plates may be joined together at both ends at a brazed joint using, for example, a brazing compound including cadmium free silver solder and high temperature brazing flux. The illustrated insert 600 is a magnetostrictive type insert in which the nickel plates can vibrate ultrasonically when a coil in the handpiece 80 is energized using the electrical signals from the cable.

The insert 600 may include at least one integral light source 601 that may be disposed substantially on and/or within the insert body 605. The light source 601 may be electrically connected to the illumination energy coil 603 by wires within the insert body 605 and the mounting arm 602.

In another exemplary embodiment, the illumination energy coil may be removable from the ultrasonic insert, as shown in FIG. 12b and FIG. 12c. The ultrasonic insert 600′ may be substantially identical to the insert 600, but may include a mounting arm 602 that may be removable from the insert body 605. The insert body 605 may include an interface port 602b that may be adapted to receive an interface jack 602a that may be included on the mounting arm 602, as shown in FIG. 12c. The interface jack 602a may be inserted into the interface port 602b such that proper electrical connection may be established between the illumination energy coil 603 and the light source 601. The mounting arm 602 may be substantially rigid, flexible or adjustable in manners similar to those discussed previously.

In some embodiments, such as the one illustrated in FIGS. 12b and 12c, all electrical elements not including connecting wires and the light source 601 may be disposed on or in proximity to the illumination energy coil 603. A circuit module 604a of sheath 604 may be used to house any circuit elements not including the light source, connecting wires and/or the illumination energy coil 603. In exemplary embodiments, the circuit module may retain any electrical components that are intended to be reusable, while, as inserts and light sources may have a defined lifetime, disposable and/or shorter lifetime components may be disposed within the insert body 605.

In one aspect, the ultrasonic dental tool includes systems for monitoring insert usage and characteristics, including but not limited to, power level, stroke amplitude, vibration frequency, and/or any other appropriate characteristics. The dental tool may include, for example, usage time monitoring circuitry, wear usage circuitry, electromagnetic monitoring circuitry and/or any other appropriate monitoring systems.

In one embodiment, the ultrasonic dental tool includes a time monitoring circuit. The time monitoring circuit may include an integrated circuit (IC) chip, which may be located on or in the insert, for recording the usage time of an ultrasonic dental insert, and an electrical signal source for supplying the IC chip with a duration signal. The duration signal may be supplied by the electrical signal source when the ultrasonic dental insert is in use. The IC chip may record the length of time the signal is on and thus may record the duration of use of an ultrasonic dental insert. The IC chip may further generate a return signal which may indicate the total recorded time. This recorded time may then be used as a suggestion to the user that a new insert may be needed. The ultrasonic unit may also include a notification or indication system for informing a user of the state of the insert, such as power level, stroke amplitude, vibration frequency, and/or any other appropriate characteristics, as noted above.

In another embodiment, the ultrasonic unit may include a time monitoring circuit which may record the duration of use of the unit. In particular, the time monitoring circuit may record the duration of a usage cycle (e.g. the time between activating the insert and deactivating the insert). The time monitoring circuit may then transmit the duration information to the IC chip on the insert, which may record an integrated time duration of the insert's usage.

In some embodiments, the IC chip may provide a predetermined maximum usage time that may limit the duration of use of the ultrasonic dental insert. The IC chip may, for example, generate a control signal which may prevent the usage of the ultrasonic dental insert by an ultrasonic unit or handpiece when the maximum usage time has been reached. In these embodiments, the IC chip may also control the activation of the unit or the unit may control activation in response to the control signal from the IC chip.

In general, the IC chip may be disposed on or in the ultrasonic dental insert, as noted above. The electrical signal source may in general be disposed on or in an ultrasonic dental unit or handpiece. In some embodiments, the IC chip may be connected to and communicate with the electrical signal source via electrical conductors. The insert may include, for example, electrical contact(s) that may interface with corresponding contact(s) on the handpiece. The contacts may be, for example, disposed at the physical connection between the insert and the handpiece. In some embodiments, the insert may include an integral sheath which may include contacts for communication between the IC chip and the electrical signal source. In other embodiments, the communication is effected by magnetic or physical contacts, such as, for example, actuators.

In other embodiments, the IC chip may communicate with the electrical signal source via a wireless connection. A wireless connection may include any appropriate communication system, such as, for example, radio frequency transmission (RF), infrared transmission, Bluetooth wireless, and/or any other appropriate system. An antenna may be utilized to transmit and/or receive such communications. The antenna may also be used to power the IC chip.

To minimize cross-talk in a dental office, such that may result from multiple inserts being in proximity, the wireless communication system may include systems to distinguish between inserts and/or provide that only one insert is recognized at a time by the electrical signal source. Examples may include, but are not limited to, limiting transmission power such that communication is only possible with an insert in very close proximity (e.g. a few centimeters), incorporating an identification and/or authentication system whereby each insert is individually identified, and/or generating an error message if more than one insert is in communication range.

In another aspect, the ultrasonic dental tool includes a mechanism(s) for monitoring electromechanical characteristics of the ultrasonic dental insert. The monitoring mechanism may include, for example, sensor(s) which may detect electromechanical characteristics of the insert. Measured electromechanical characteristics may include, but are not limited to, power level, stroke amplitude, vibration frequency, and/or any other appropriate characteristic. The monitoring mechanism may be disposed on or in the ultrasonic dental insert or in the ultrasonic unit.

In one embodiment, the ultrasonic dental unit may include systems for storing established reference values for insert electromechanical characteristics and comparing these reference values to the detected values from the insert, either a new insert or after the insert has been in use. The unit may then determine whether the insert is performing within or outside a predetermined acceptable range of performance.

In another embodiment, a monitoring system may include an energy dissipating system. IC chips may be subject to overpowering and/or electric shorting from an excess of electric current. This may be particularly problematic in systems such as IC chips that are wirelessly powered by antennas and/or coils. An energy dissipating system may be included to consume at least a portion of the electric current that would be provided to a monitoring system. This may aid in preventing overpowering and/or shorting of components of the monitoring system, such as, for example, an IC chip. An energy dissipating system may include, but is not limited to, resistors, inductors, capacitors, combinations thereof, and/or any other appropriate system.

In yet another embodiment, a control mechanism may be provided to inhibit the use of an insert 300 when the insert does not have an identification marker that is recognized by the unit and/or handpiece 80. One aspect of the control mechanism is that the inhibition occurs during the attachment process of the insert 300 to the handpiece 80. In one embodiment, the control mechanism inhibits the operation of the unit. In another embodiment, the control mechanism inhibits the operation of the handpiece 80.

According to one embodiment, the unit and/or handpiece 80 includes a recognizer that may be programmed to recognize or operate an insert 300 having a particular identification marker. According to another embodiment, the unit and/or handpiece 80 may include a chip with a recognizing mechanism that activates an insert 300 only if only certain features are on the insert 300 to be recognized. Such markers may be incorporated into the chip or be a part for completing an electrical circuit so that without it, the circuit remains open. In general, the markers may not be removable once incorporated.

In still another embodiment, the insert includes a light source. The light source may share a power source with a monitoring system and may further act as an energy dissipating system by consuming electric current and converting the energy into light. The light source may in general be disposed to direct light to the field of work.

In still other embodiments, the monitoring system may draw power from an illumination energy coil, such as those described above.

In the embodiments described above, a coil may include any appropriate structure that may define at least a part of closed electrical pathway that may be induced by an appropriate changing magnetic flux. Such structures may include a single wire coil, multiple wire coils, wire flat spirals, wire conical coils and/or any other appropriate conductive structure that may properly be induced by a changing magnetic flux. Wire structures may be wound about a structurally defining element, formed and retained by their own rigidity, formed and retained within a structural material such as resin, and/or by any other appropriate method.

In some embodiments, wire structures may be disposed on or within a flexible substrate and may be formed into an appropriate shape, orientation and/or form. For example, wire segments and/or structures may be disposed within a tape or other appropriate strip-like material. Such tape may then be wrapped around structurally defining elements to define wire structures such as coils. Electrical contacts may be disposed on the tape such that the embedded wires may be connected to other electrical elements. Appropriate materials for embedding wire structures may include any substantially flexible and non-conductive materials, such as, for example, polyimide films such as Kapton produced by DuPont.

It will be appreciated by those of ordinary skill in the art that the present invention can be embodied in other specific forms without departing from the spirit or essential character hereof. The present description is therefore considered in all respects to be illustrative and not restrictive. The scope of the present invention is indicated by the appended claims, and all changes that come within the meaning and range of equivalents thereof are intended to be embraced therein.

1. An ultrasonic dental tool comprising:
a dental insert comprising a transducer, a connecting body having a tip thereon and a housing having a grip portion and a sheath; and
a handpiece having a hollow interior with a primary coil disposed therein;
wherein said sheath extends from said housing about said transducer and fits around said handpiece during use.

2. The dental tool of claim 1 further comprising at least one light source.

3. The dental tool of claim 2 further comprising a coil disposed proximal to said connecting body, said coil generates a voltage signal in response to vibration of said connecting body during insert use and powers said at least one light source.

4. The dental tool of claim 2 further comprising a coil supported by said sheath, said coil being inductively coupled to said primary coil of said handpiece during insert use and generates a voltage signal to power said at least one light source.

5. The dental tool of claim 1 further comprising at least a portion of a monitoring mechanism wherein said monitoring mechanism monitors at least one electromechanical characteristic or duration of use of said dental insert and communicates said characteristic or duration to an ultrasonic unit for indication to a user.

6. The dental tool of claim 1 wherein said sheath is integral to said dental insert.

7. The dental tool of claim 1 wherein said sheath is supported by said dental insert.

8. The dental tool of claim 1 wherein said grip portion is part of said sheath.

9. The dental tool of claim 3 wherein said coil further comprises a rectifier circuit.

10. The dental tool of claim 4 further comprising at least a second coil disposed proximal to said connecting body, said second coil generating a voltage signal in response to vibrations of said connecting body during said dental insert use and powers said at least one light source in conjunction with said coil supported by said sheath.

11. The dental tool of claim 1 further comprising at least a portion of a control mechanism, said control mechanism controls activation of said dental insert or handpiece.

12. The dental tool of claim 11 wherein said control mechanism comprises an identification marker and recognizer.

13. An ultrasonic dental insert comprising:
a transducer;
a connecting body having a tip thereon;
at least one light source;
at least one coil disposed proximal to said connecting body; and
a housing having a grip portion and a sheath, said sheath extending from said housing about said transducer and fitting over an ultrasonic dental handpiece during said ultrasonic dental insert use;
wherein said at least one coil generates a voltage signal in response to vibrations of said connecting body during said ultrasonic dental insert use and powers said at least one light source.

14. The ultrasonic dental insert of claim 13 further comprising at least one magnetic material disposed proximal to said connecting body.

15. The ultrasonic dental insert of claim 13 further comprising at least a second coil supported by said sheath, said at least one coil generates a voltage signal in response to vibrations of said connecting body during insert use and powers said at least one light source in conjunction with said second coil supported by said sheath.

16. The ultrasonic dental insert of claim 13 further comprising at least one magnetic material disposed proximal to said connecting body.

17. The ultrasonic dental insert of claim 13 wherein said at least one coil further comprises a rectifier circuit.

18. The ultrasonic dental insert of claim 13 further comprising at least a portion of a control mechanism, said control mechanism controls activation of said ultrasonic dental insert.

19. The ultrasonic dental insert of claim 13 further comprising at least a portion of a monitoring mechanism wherein said monitoring mechanism monitors at least one electromechanical characteristic or duration of use of said dental insert and communicates said characteristic or duration to a user.

20. The insert of claim 13 further comprising a light transport for transporting light to a work field.

21. An ultrasonic dental tool comprising:
an insert comprising:
a first transducer for generating ultrasonic vibrations;
a connecting body having a proximal end and a distal end having a tip thereon, said proximal end is attached to said first transducer so as to receive the ultrasonic vibrations therefrom and to transmit the ultrasonic vibrations toward said tip attached to said distal end; and
at least one attachable light source substantially proximate to said tip for delivering light to a field of work; and
a handpiece adapted for powering said insert;
wherein said at least one attachable light source comprises an illumination energy coil comprising a rectifier circuit.

22. The ultrasonic dental tool of claim 21 wherein said illumination energy coil further comprises a positioning member.

23. The ultrasonic dental tool of claim 21 wherein said handpiece comprises a substantially hollow housing and a primary power source, said power source comprises a coil for inductively coupling to said illumination energy coil of said at least one attachable light source.

24. The ultrasonic dental tool of claim 22 wherein said positioning member comprises a rigid arm or a flexible arm.

25. The ultrasonic dental tool of claim 21 further comprising a light source proximate and parallel to a longitudinal axis of said illumination coil.

26. The ultrasonic dental tool of claim 21 wherein said rectifier circuit comprises a half-wave or a full-wave rectifier.

27. The ultrasonic dental tool of claim 21 wherein said illumination energy coil comprises a mounting member for positioning said light source on the outside of said handpiece.

28. The ultrasonic dental tool of claim 27 wherein said mounting device encloses said light source.

29. The ultrasonic dental tool of claim 21 wherein said insert further comprises a handgrip portion, said handgrip portion at least partially encloses said at least one attachable light source.
